(19) United States
(12) Patent Application Publication
(10) Pub. No.: US 2009/0152149 A1
(43) Pub. Date: Jun. 18, 2009

(54) Tool and equipment organizer

(76) Inventor: Jeffery Scott Allen, Leesburg, VA (US)

Correspondence Address: Jeffery Scott Allen, 17623 Tobermory Place, Leesburg, VA, 20175, US

(21) Appl. No.: 12/000,461

(22) Filed: Dec. 13, 2007

(51) Int. Cl. B65D 85/00; B23P 17/00; B65D 25/28

(52) U.S. Cl. 206/373; 220/768; 29/592

(57) ABSTRACT

A system and method for organizing tools and equipment is disclosed. The system comprises a front wall for securing at least one chain of a first length using a first tension element and a plurality of holding elements; a rear wall for securing at least one chain of a second length using a second tension element and a plurality of holding elements; a first side wall for securing at least one tool with at least one clamp device; a second side wall; a bottom wall; and a top wall having a pull or handle element attached thereto, wherein the top, bottom, second side, first side, front and rear walls all cooperate to form a cavity for storing at least one tool.

### FIELD OF THE INVENTION

The system described herein generally relates to a tool organizer, and more particularly to a tool and equipment organizer for assisting in the transportation of tools and equipment to an elevated location.

### BACKGROUND OF THE INVENTION

Fire fighting is all about speed and efficiency. Lives and property can be saved with the right tools and a quick response. Yet, these tools and accessories are of no benefit unless they are organized and rapidly deployed.

Chain saws are a crucial tool in the fight against fire. Chain saws are used to cut ventilation holes in the roofs of occupied structures that are on fire. These vent holes increase the chances of survival for the occupants by releasing the smoke and toxic fumes created by the fire. Quick ventilation also allows for a rapid and more effective primary search for victims. The cutting of roofs is very damaging to the chain saw's chain. Most often chains need to be changed during a ventilation cut. Currently, chain saws and rotary saws must be sent down off the roof to have a new chain or blade placed on the saw. This is time consuming and inefficient. A fire can double in size every ninety (90) seconds. Time is crucial and lives and property can be saved by having these chains, blades and tools and other equipment readily accessible at the roof level.

Thus, what is needed is a tool and equipment organizer that can enable the rapid and safe deployment of tools and equipment to a desired location.

### SUMMARY OF THE INVENTION

According to various embodiments, the system and apparatus described herein may comprise a tool and equipment organizer, such as a chain and blade organizer (“CABO”), for example, which may be used to rapidly and safely deploy and hoist equipment to a desired location, such as the roof of a structure or other elevated location. Fire fighters, for example, typically use chain saws to open holes in roofs to release smoke and toxic fumes created by the fire. Many times, the chains or saws used to create the openings get worn down and need to be replaced quickly. As constructed, the CABO described herein retains chains and blades in such a manner that are quickly placed on the saws without sending a firefighter down the ladder.

In contrast to existing compartments which require the placement of tools and equipment in separate devices (e.g., chains in one container, saws in another), the CABO described herein retains the tools and chains on the outside of a single device so that fire fighters, for example, may quickly and safely access and deploy the necessary tools and equipment. Thus, replacement chains, saws and other tools may be deployed to the desired location all at once.

In some embodiments, the CABO has six sides: a front side, a rear side, a top side, a bottom side, a left side and a right side, all of which cooperate to form a CABO which may comprise a cube or other box-like structure. Each side serves a function in the deployment of tools and equipment. For example, the front and rear sides of the CABO may secure the saw chains. In some embodiments, the chains may be held in place by a tension system or element that applies sufficient force against the chain and cooperates with a plurality of holding elements to ensure the chain does not disengage or otherwise become disconnected or fall off the CABO. This arrangement allows for quick deployment and removal of chains, and permits the easy day to day inspection of the chains when the CABO is held in storage or otherwise not in use.

In some embodiments, the CABO may retain multiple chains. For example, a plurality of chains may be arranged in a side-by-side fashion and held in place by the tension element and holding elements. This feature helps ensure that a chain (or a plurality of chains) does not form loops which may cause knotting or entanglement. These loops are a major problem with the way that chains have been carried in the past. Loops and knots form and entanglement may occur when chains are carried in a common tool box or stored in an otherwise unorganized manner. As a result, it is very common to see a firefighter spend several minutes attempting to detangle a knotted or entangled chain. The CABO solves this common problem.

In some embodiments, the front and rear sides may each hold chains of different lengths. For example, the front side may retain 20″ chains, while the rear side secures 18″ chains. This is another important and time saving feature of the CABO. In the past it was difficult to distinguish between different lengths of chain due to the loops. With the chain housing system you can readily see how many 18″ chains and 20″ chains you have at a glance. There is no chance of sending up the wrong chain length. No time will be wasted sorting out different chain lengths.

In some embodiments, the left side of the CABO may house rotary saw blades. For example, the left side may contain an opening to a cavity defined by the other sides or walls of the CABO and in which saw blades and other equipment may be stored and retained for deployment. The size of the cavity is large enough to retain saws of different sizes, such as the roughly four different cut saw blade types.

In some embodiments, the right side of the CABO may secure the tools that are used for changing chains and blades. For example, the right side may contain a plurality of tool retaining elements that individually retain particular tools, such as a screwdriver or hammer, for example. In some embodiments, each tool retaining element may comprise a clamp having two arms which cooperate (using friction) to retain a particular tool in a stationary position during deployment and storage. The friction between the arms and the tool is such that a tool may be removed easily, yet enough so that the tool will not become disengaged from the CABO during deployment.

According to various embodiments of the systems and methods described herein, a system for organizing tools and equipment is provided. The system comprises a front wall for securing at least one chain of a first length using a first tension element and a plurality of holding elements; a rear wall for securing at least one chain of a second length using a second tension element and a plurality of holding elements; a first side wall for securing at least one tool with at least one clamp device; a second side wall; a bottom wall; and a top wall having a pull or handle element attached thereto, wherein the top, bottom, second side, first side, front and rear walls all cooperate to form a cavity for storing at least one tool.

In yet other embodiments of the systems and methods described herein, a method for manufacturing a tool and equipment organizer is provided. The method comprising the steps of: attaching a first tension element and a plurality of holding elements to a first wall; attaching a second tension element and a plurality of holding elements to a second wall; attaching at least one tool element to a third wall; attaching the first, second and third walls to each other; attaching a top wall, a bottom wall, and a fourth wall to the first, second and third walls, wherein the top, bottom, first, second, third and fourth walls cooperate to form a cavity for storing at least one tool.

In its various embodiments, the CABO described herein is an effective answer to the storage and deployment problems of saws, chains and other tools used in fire fighting. Presently, there is nothing on the market that does what the CABO does. Rapid accessibility, chain and blade accountability, and speedy transport to the roof of a structure involved with fire are now possible with the CABO.

### BRIEF DESCRIPTION OF THE DRAWINGS

FIG. 1 depicts a top perspective of a CABO, according to one embodiment of the invention.

FIG. 2 depicts a side perspective of a CABO, according to one embodiment of the invention.

FIG. 3 depicts a front perspective of a CABO, according to one embodiment of the invention.

FIG. 4 depicts a rear perspective of a CABO, according to one embodiment of the invention.

FIG. 5 depicts a side perspective of a CABO, according to one embodiment of the invention.

FIG. 6 depicts a method for manufacturing a CABO, according to one embodiment of the invention.

### DETAILED DESCRIPTION OF THE INVENTION

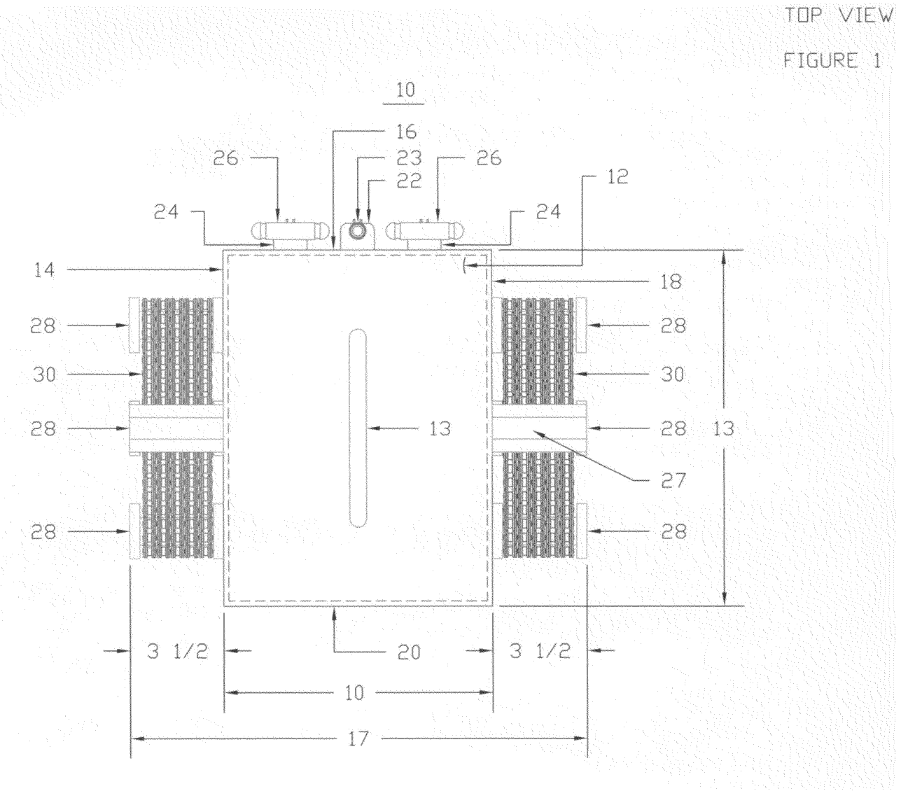

FIG. 1 illustrates a top view of a CABO 10, according to one embodiment of the systems described herein. As shown, CABO 10 may comprise a pull or handle element 13 disposed on and secured to top wall or portion 12. Pull or handle element may be used to attach CABO 10 to a lift or pulley device (not shown) that can deploy the CABO 10 to the necessary location. Pull or handle element 13 may also be used by an individual to carry CABO 10 as needed. Also shown are a plurality of holding elements 28 and a tension element 27 disposed on and secured to walls or portions 14 and 18 that cooperate to retain one or a plurality of chains 30. In some embodiments, the chains 30 shown in the left side of FIG. 1 are of a different length than the chains 30 shown on the right side. Also shown are tool holding elements 22 and 24 disposed on wall or portion 16 which operate to retain tools 23 and 26. In some embodiments, walls or portion 12, 16 and 18, pull or handle 13, tension element 27, holding elements 28 and tool holding elements 22 and 24 may be made of any plastic, wood, metal, alloy or other hard material to ensure durability.

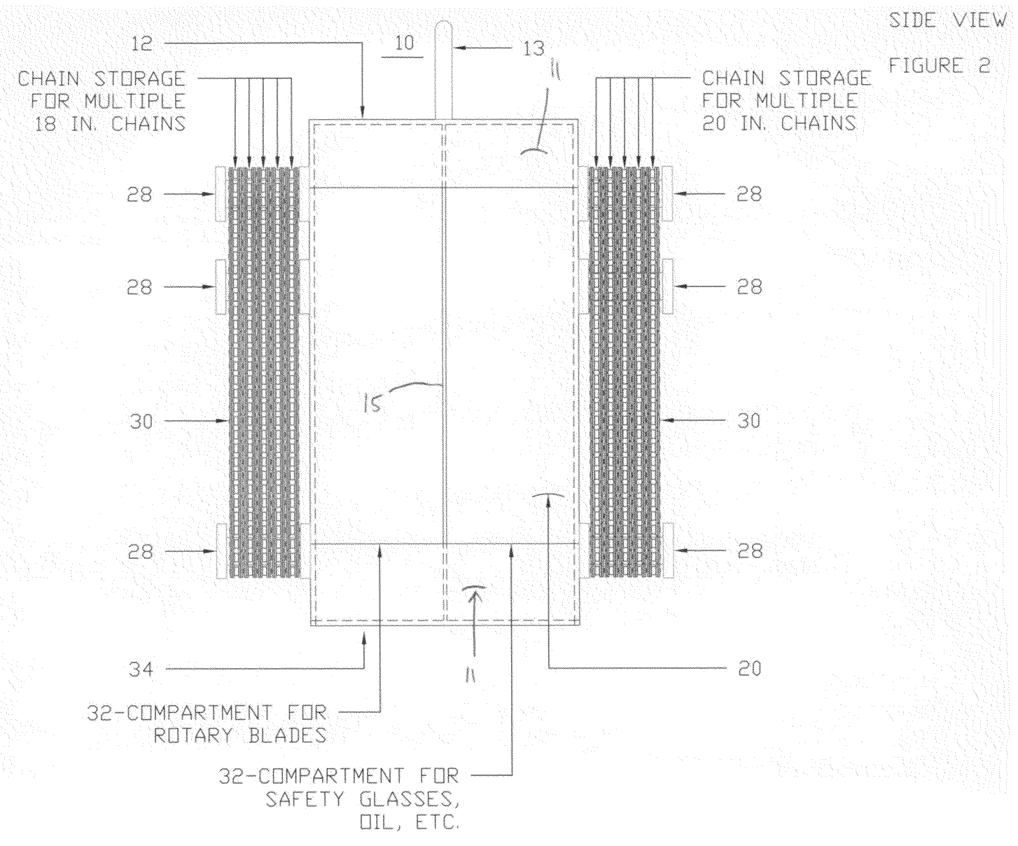

FIG. 2 illustrates a side view of a CABO 10, according to one embodiment of the systems described herein. As shown, walls or portions 11 form a cavity 20 in which tools, such as chain saws or blades, for example, may be stored and retained for deployment. In some embodiments, cavity 20 may contain at least one compartment 32 for retaining saws or blades of a particular size as well as other equipment, such as safety glasses, oil, etc. For example, wall 15 may define two compartments 32 for storing desired tools and equipment. Also shown in FIG. 2 is a side view perspective of the chains 30, pull or handle 13 and holding elements 28.

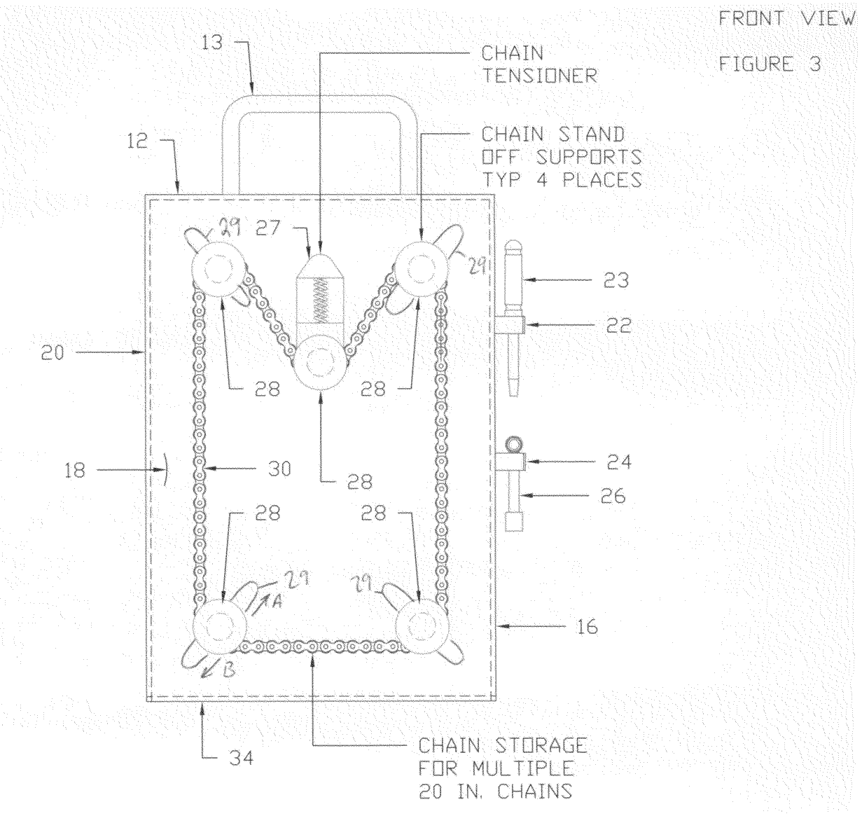

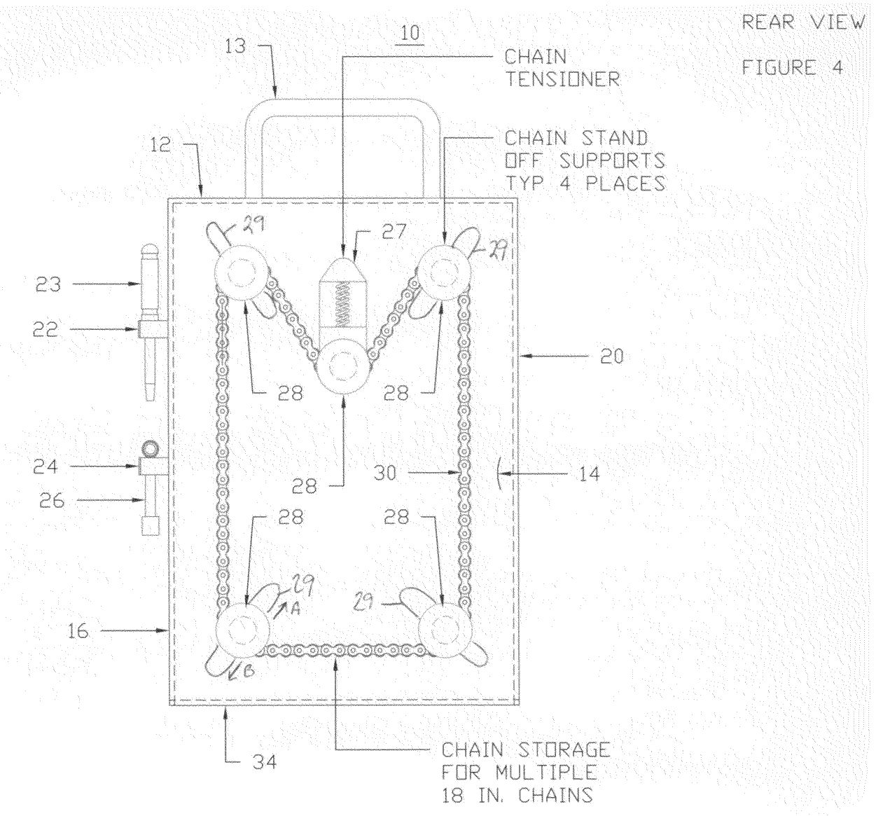

FIGS. 3 and 4 illustrate front and side views of a CABO 10, respectively, according to one embodiment of the systems described herein. As shown, each view depicts a tension element 27 and a plurality of holding elements 28 that cooperate to retain a single or plurality of chains 30. In some embodiments, tension element and holding elements disposed on wall 18 may cooperate to retain a plurality of chain saw chains of a particular length, while tension element and holding elements on wall 14 may cooperate to retain a plurality of chain saw chains of the same, lesser or greater length. In some embodiments, a chain may be mounted on the outer periphery formed by the plurality of the holding elements 20 and in the inner periphery of the tension element 27. This way, the spring in tension element 27 may urge the chain inward and thereby apply sufficient tension and friction to retain the chain in a secure and stationary position for deployment. An individual seeking to remove a chain may selectively compress tension element 27 to loosen the chain and facilitate removal. In some embodiments, holding elements 28 may be retained within a slot 29 in which holding elements may be selectively positioned to accommodate chains of longer or shorter length. For example, for shorter chains, holding elements 28 may be moved towards the center of walls 14 and 18 for shorter chains (as shown by A), and towards the outer borders for longer chains (as shown by B). In some embodiments, the position of a holding element 28 may be maintained by tightening a bolt attached to the back of each holding element 28 which presses against the back of wall 14 or 18. Other techniques for securing holding elements 28 within slots 29 are of course possible.

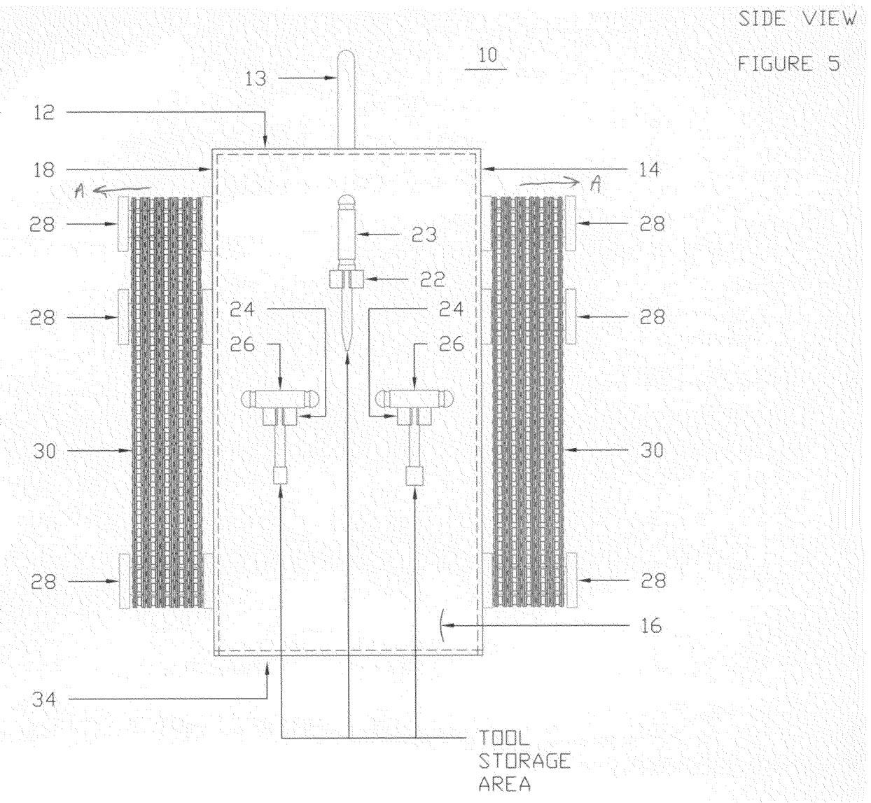

FIG. 5 illustrates a side view of a CABO 10, according to an embodiment of the systems and methods described herein. As shown, a plurality of tool holding elements 22 and 24 are disposed on wall or portion 16. In some embodiments, each tool holding element 22 and 24 may comprise a clamp device which contains a first arm and a second arm that cooperate to retain the at least one tool with friction. As shown, tool holding device 22 may retain a screwdriver 23, while tool holding elements 24 may retain a hammer or like device 26. Other tools may of course be retained. In some embodiments, holding elements 28 may telescope (e.g., in the direction of A) so as to accommodate additional chains. For example, each holding element 28 may be adjusted so that the chains may fit in a snug and secure manner (as shown) to prevent movement of the chain during storage or deployment. The precise number of chains being accommodate would of course determine the position of the holding elements. The telescopic movement may be accomplished by a holding element 28 that collapses within itself when shortened and in the opposite direction when enlarged. In some embodiments, the holding element may simply be pushed within walls 14 and 18 to accommodate less chains and pulled out to accommodate more chains. Other techniques for achieving the telescopic effect are possible.

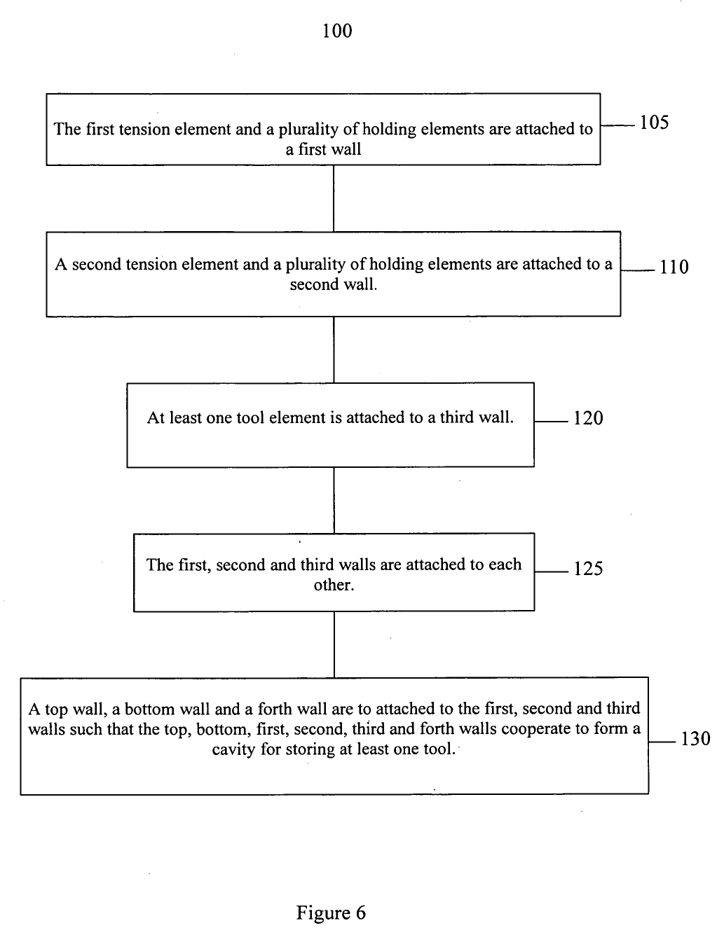

FIG. 6 illustrates a method 100 for manufacturing a tool and equipment organizer, according to one embodiment of the systems and methods described herein. At step 105, a first tension element and a plurality of holding elements are attached to a first wall. At step 110, a second tension element and a plurality of holding elements are attached to a second wall. At step 115, at least one tool element is attached to a third wall. At step 120, the first, second and third walls are attached to each other. At step 125, a top wall, a bottom wall, and a fourth wall are attached to the first, second and third walls such that the top, bottom, first, second, third and fourth walls cooperate to form a cavity for storing at least one tool. In some embodiments, the various elements and walls and components disclosed herein may be arranged in a manner to compose the various tool and equipment organizer described herein.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

For example, the CABO is incredibly versatile. Construction companies, arborists, and wild land firefighters, for example, may all find the CABO to be extremely beneficial to their particular line of work. Moreover, different configurations may be made to suit particular needs. For example, the construction company may use more rotary saws than chain saws. An embodiment of the CABO may be made to accommodate more rotary blades and less chain saw chains.

Similarly, an arborist may opt for an embodiment that folds three or more different types of chains, each of which may be disposed on different sides of the CABO. Considering that the arborist would not likely use the rotary saw, more space may be devoted to specific tools on the tree expert. In addition, the top of the CABO may be made with slots to hold extra chain saw bars. Different length bars are often used in the tree trimming business, and the organizational benefits of the CABO may be readily realized and appreciated.

Wild land firefighters may also benefit from an embodiment of CABO specifically made for their needs. The chain saw in an everyday tool of the wild land firefighter. A lightweight model (e.g., made of durable plastic or aluminum) may increase mobility for use in the woods.

In some embodiments, different materials may be used to construct the different components and parts of the CABO, depending on the needs of the particular application. These alterations to the CABO may make it widely useful and marketable to fire departments, construction companies, arborists, and other industries and fields.

1. A system for organizing tools and equipment, comprising:
a front wall for securing at least one chain of a first length using a first tension element and a plurality of holding elements;
a rear wall for securing at least one chain of a second length using a second tension element and a plurality of holding elements;
a first side wall for securing at least one tool with at least one clamp device;
a second side wall;
a bottom wall; and
a top wall having a pull or handle element attached thereto,
wherein the top, bottom, second side, first side, front and rear walls all cooperate to form a cavity for storing at least one tool.

2. The system of claim 1 wherein the first and second tension elements comprise a spring element.

3. The system of claim 1 wherein the first length is greater than the second length.

4. The method of claim 1 wherein the at least one chain comprises a chain saw chain.

5. The method of claim 1 wherein the at least tool retained by the first side wall comprises a screwdriver or a hammer.

6. The method of claim 1 wherein the at least one clamp device comprises a first arm and a second arm that retain the at least one tool with friction.

7. The method of claim 1 wherein the at least one tool retained by the cavity comprises at least one rotary saw blade.

8. The method of claim 1 wherein the front, rear, first side, second side, top and bottom walls are all composed of wood, plastic, metal, allow, composite or other hard material.

9. The method of claim 1 wherein the at least one chain comprises a plurality of chain saw chains.

10. A method for manufacturing a tool and equipment organizer, comprising:
attaching a first tension element and a plurality of holding elements to a first wall;
attaching a second tension element and a plurality of holding elements to a second wall;
attaching at least one tool element to a third wall;
attaching the first, second and third walls to each other;
attaching a top wall, a bottom wall, and a fourth wall to the first, second and third walls,
wherein the top, bottom, first, second, third and fourth walls cooperate to form a cavity for storing at least one tool.
